(19) United States
(12) Patent Application Publication
(10) Pub. No.: US 2026/0071336 A1
(43) Pub. Date: Mar. 12, 2026

(54) ELECTROLYZER USING RECOVERABLE PROCESS HEAT

(71) Applicant: Advanced Ionics, Inc., New Berlin, WI (US)

(72) Inventors: Chad Mason, Cudahy, WI (US); Richard Samuel Kempf, Wauwatosa, WI (US); Ignacio Claudio Bincaz, Houston, TX (US); Michael E. Donovan, Milwaukee, WI (US); William R. Murray, New Berlin, WI (US)

(73) Assignee: Advanced Ionics, Inc., New Berlin, WI (US)

(21) Appl. No.: 19/318,724

(22) Filed: Sep. 4, 2025

Related U.S. Application Data
(60) Provisional application No. 63/690,353, filed on Sep. 4, 2024.

(51) Int. Cl. C25B 9/67; C25B 1/042; F22B 1/16; F22G 1/14; F28D 21/00

(52) U.S. Cl. CPC C25B 9/67; C25B 1/042; F22B 1/16; F28D 21/001; F22G 1/14

(57) ABSTRACT

A system for producing hydrogen gas comprising: a heat exchanger module; the heat exchanger comprising: a warming module; and a boiler; a converter module; the converter module comprising a superheater, vaporizer, and/or compressor; an electrolyzer in communication with the converter module; and the electrolyzer in communication with the heat exchanger module. A method for producing hydrogen gas comprising: passing a working fluid into a heat exchanger module comprising warming module and a boiler to form a vapor-phase working fluid; passing the vapor-phase working fluid into a converter module comprising a superheater, vaporizer, and/or compressor to form a converted working fluid; passing the converted working fluid into an electrolyzer to form hot hydrogen gas and hot oxygen gas; passing the hot oxygen gas and/or hot hydrogen gas into the heat exchanger module.

### CROSS-REFERENCE TO RELATED APPLICATIONS

This application claims priority to and the benefit of the filing of U.S. Provisional Patent Application No. 63/690,353, entitled “ELECTROLYZER USING RECOVERABLE PROCESS HEAT”, filed on Sep. 4, 2024, and the specification and claims thereof are incorporated herein by reference.

### BACKGROUND OF THE INVENTION

### Field of the Invention (Technical Field)

The present invention relates to electrolyzers, and particularly to electrolyzers operating at relatively low temperatures using heat from industrial processes.

### BACKGROUND

Many industrial processes produce heat of a somewhat elevated temperature, often in the form of hot water/steam, hot oil, and/or therminol. What is needed is an electrolyzer system configured to recover process heat to when producing products such as hydrocarbons.

### BRIEF SUMMARY OF THE INVENTION

Embodiments of the present invention relate to a system for producing hydrogen gas comprising: a heat exchanger module; the heat exchanger module comprising: a warming module; and a boiler; a converter module; an electrolyzer in communication with the converter module; the electrolyzer in communication with the heat exchanger module; and the heat exchanger module configured to receive process heat. In another embodiment, the converter module comprises a superheater. In another embodiment, the converter module comprises a vaporizer. In another embodiment, the converter module comprises a compressor. In another embodiment, the heat exchanger module is configured to receive excess process power. In another embodiment, the heat exchanger module is configured to receive excess process electricity.

In another embodiment, the heat exchanger module is configured to receive heat from heated hydrogen. In another embodiment, the heat exchanger module is configured to receive heat from heated oxygen. In another embodiment, the converter module is configured to receive heat from heated hydrogen. In another embodiment, the converter module is configured to receive heat from heated oxygen. In another embodiment, the system further comprises an expander turbine in communication with the heat exchanger module. In another embodiment, the system further comprises a hydrogen heat exchanger in communication with the electrolyzer and the heat exchanger module. In another embodiment, the system further comprises a thermo-compressor in communication with the heat exchanger module. In another embodiment, the system further comprises a working fluid.

Embodiments of the present invention also relate to a method for producing hydrogen gas comprising: passing water into a heat exchanger module comprising warming module and a boiler to form a vapor-phase water; passing the vapor-phase water into a converter module to form a converted steam; passing the converted steam into an electrolyzer to form hot hydrogen gas and hot oxygen gas; transferring heat from the hot oxygen to the converter module; and transferring process heat into the heat exchanger module. In another embodiment, the method further comprises passing the hot oxygen gas into the heat exchanger module. In another embodiment, the method further comprises passing the hot hydrogen gas into the heat exchanger module. In another embodiment, the converter module comprises a superheater. In another embodiment, the converter module comprises a vaporizer. In another embodiment, the converter module comprises a compressor.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a prior art diagram showing an electrolyzer stack, according to an embodiment of the present invention;

FIG. 2 is a diagram showing a hydrogen separator system, according to an embodiment of the present invention;

FIG. 3 is a diagram showing a system for producing hydrogen comprising a heat exchanger module, according to an embodiment of the present invention;

FIG. 4 is a diagram showing a system for producing hydrogen comprising a hydrogen heat exchanger, according to an embodiment of the present invention;

FIG. 5 is a diagram showing a system for producing hydrogen comprising an expander turbine, according to an embodiment of the present invention;

FIG. 6 is a diagram showing a system for producing hydrogen comprising a thermo-compressor, according to an embodiment of the present invention;

FIG. 7 is a diagram showing a system for producing hydrogen comprising a catalytic converter, according to an embodiment of the present invention;

FIG. 8 is a diagram showing a system for producing hydrogen comprising a liquid working fluid, according to an embodiment of the present invention;

FIG. 9 is a diagram showing a system for producing hydrogen comprising a gaseous working fluid, according to an embodiment of the present invention;

FIG. 10 is a diagram showing a system for producing hydrogen comprising a heat pump system, according to an embodiment of the present invention;

FIG. 11 is a diagram showing a system for producing hydrogen comprising a compressor, according to an embodiment of the present invention;

FIG. 12 is a diagram showing a system for producing hydrogen comprising a heat pump system comprising a vaporizer, according to an embodiment of the present invention;

FIG. 13 is a diagram showing a system for producing hydrogen comprising a heat transfer buffer loop, according to an embodiment of the present invention;

FIG. 14 is a diagram showing a system for producing hydrogen comprising a recovered hot working fluid in communication with a vaporizer, according to an embodiment of the present invention;

FIG. 15 is a diagram showing a system for producing hydrogen comprising a recovered hot working fluid in communication with a superheater, according to an embodiment of the present invention;

FIGS. 16A to 16B are diagrams showing a system for producing hydrogen comprising an anode separator in communication with an electrolyzer stack, according to an embodiment of the present invention;

FIGS. 17A to 16B are diagrams showing a system for producing hydrogen comprising an anode recuperator in communication with an electrolyzer stack, according to an embodiment of the present invention;

FIGS. 18A to 16B are diagrams showing a system for producing hydrogen comprising an anode economizer, according to an embodiment of the present invention; and

FIGS. 19A to 16B are diagrams showing a system for producing hydrogen comprising an expander and recycle compressor, according to an embodiment of the present invention.

### DETAILED DESCRIPTION OF THE INVENTION

Embodiments of the present invention relate to a system for producing hydrogen gas comprising: a heat exchanger module; the heat exchanger comprising: a warming module; and a boiler; a converter module; the converter module comprising a superheater, vaporizer, and/or compressor; an electrolyzer in communication with the converter module; and the electrolyzer in communication with the heat exchanger module.

Embodiments of the present invention also relate to a method for producing hydrogen gas comprising: passing a working fluid into a heat exchanger module comprising warming module and a boiler to form a vapor-phase working fluid; passing the vapor-phase working fluid into a converter module comprising a superheater, vaporizer, and/or compressor to form a converted working fluid; passing the converted working fluid into an electrolyzer to form hot hydrogen gas and hot oxygen gas; passing the hot oxygen gas and/or hot hydrogen gas into the heat exchanger module.

From the foregoing disclosure and the following more detailed description of various embodiments it will be apparent to those skilled in the art that the present invention provides a significant advance in the technology of electrolyzers. The system may use recoverable process heat to make valuable products including, but not limited to, H₂ gas, O₂ gas, or a combination thereof. Additional elements and advantages of various embodiments will be better understood in view of the detailed description provided below.

It will be apparent to those skilled in the art that many uses and design variations are possible for the electrolyzer disclosed here. The following detailed discussion of various alternate elements and embodiments will illustrate the general principles of the invention with reference to a plant which generates substantial process heat typically in the form of steam, such as an ammonia plant or other industrial process, where the recoverable process heat would otherwise not be used as effectively. Other embodiments suitable for other applications will be apparent to those skilled in the art given the benefit of this disclosure.

The term “process heat” as used herein means heat generated from an industrial, manufacturing, or site operation process including, but not limited to, power plant operation; hydrocarbon production; chemical manufacturing; data center operation; medical campus operation; education campus operation; tech campus operation; mineral production; or a combination thereof.

The term “hydrogen heat exchanger” as used herein means a heat exchanger wherein hydrogen at a higher temperature (i.e., hot hydrogen) heats hydrogen at a lower temperature.

The term “working fluid” as used herein means any fluid used as a heat exchange medium and includes, but is not limited to ethanol, another alcohol, an organic fluid, carbon dioxide, air, ammonia, siloxane, hydrocarbons, or a combination thereof. The working fluid may be liquid and/or gas. The working fluid may an open and/or close loop.

The term “low-pressure steam” as used herein means a vaporized phase of a fluid with a pressure that is less than about 9.5 bar (g).

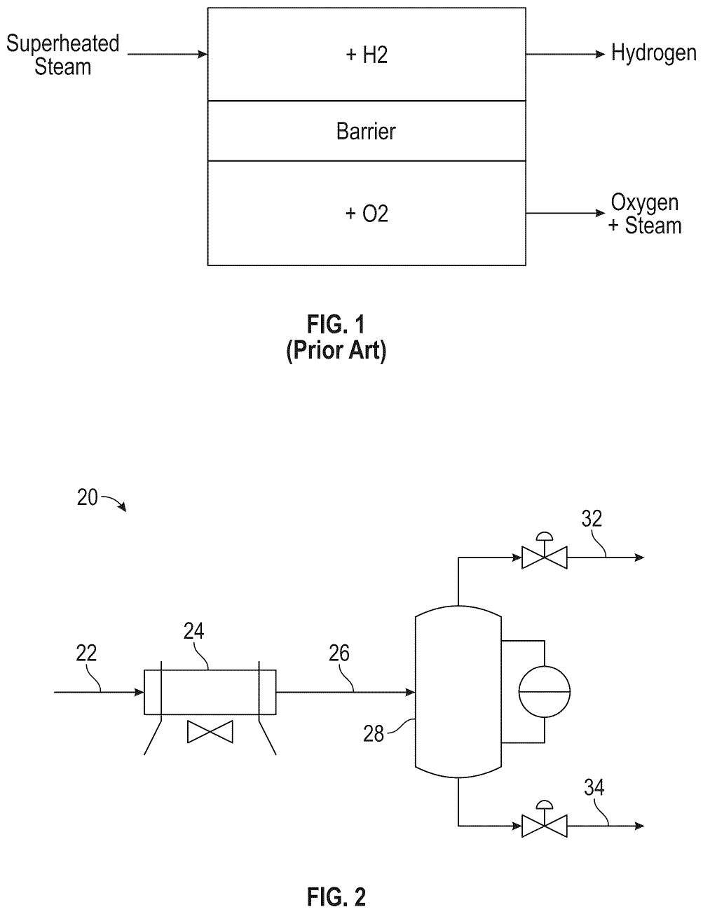

Turning now the figures, FIG. 1 shows an electrolyzer stack. FIG. 1 shows a simplified schematic of an electrolyzer for use with recoverable process heat and that may be operated at temperatures well below that of known solid oxide electrolyzers, advantageously allowing for the use of less expensive materials.

Recoverable process heat from an industrial process may be captured and put to useful work to heat an input reactant fluid (e.g., steam, water, or other fluid) which in turn is fed to the electrolyzer to generate an output product, such as hydrogen gas and/or oxygen gas. The electrolyzer may produce a hydrogen product near the electrolyzer temperature. As shown the electrolyzer comprises a cathode, an electrolyte, and an anode with the electrolyte positioned between the electrodes. The electrolyzer may operate at a temperature and an operating pressure. For example, the electrolyzer may operate at a temperature range of at least about 150° C., about 150° C. to about 600° C., about 200° C. to about 550° C., about 250° C. to about 500° C., about 300° C. to about 450° C., or about 600° C. The operating pressure of the electrolyzer may be atmospheric pressure, or above atmospheric, for example, at least about 1.5 atmospheres (“atm”), about 1.5 atm to about 10 atm, about 2 atm to about 9 atm, about 3 atm to about 8 atm, about 4 atm to about 7 atm, or about 10 atm. The electrodes may comprise a first stainless steel as the cathode where hydrogen is evolved, and a second stainless steel as the anode where the oxygen is evolved. Both of the stainless steels can comprise 316 steel. The electrolyte may comprise a metal oxide.

The electrolyzer may be formed in a housing as a series of one or more plates. The plates may be arranged in series such that steam (typically superheated steam) passes by each plate sequentially, from cathode to anode. Other geometries for the electrolyzer will be readily apparent to those skilled in the art given the benefit of this disclosure. During operation a low voltage electric field is applied across the electrolyzer plates using a current generator and may be at least about 0.5 amperes per square centimeter (“amp/cm²”), about 0.5 amp/cm² to about 5 amp/cm², about 1 amp/cm² to about 4.5 amp/cm², about 1.5 amp/cm² to about 4 amp/cm², about 2 amp/cm² to about 3.5 amp/cm², about 2.5 amp/cm² to about 3 amp/cm², or about 5 amp/cm² of plate area. A cathode manifold may be provided at the cathode of each plate to collect the hydrogen gas evolved there, and an anode manifold may be provided at the anode of each plate to collect the oxygen gas evolved at the anode. Water vapor may also be present at each manifold.

The electrolyzer may be component of a larger device (e.g., a hydrocarbon or power plant) which may deliver input water to the electrolyzer along a first input line. The input water may have a first pressure and a first temperature in the first line which may be below the operating temperature and the operating pressure, respectively, at the electrolyzer. To raise the temperature, a temperature control module may be positioned in the first or input line for changing the first (i.e., input) temperature of the input water up to the operating temperature. The temperature control module may comprise a heat exchanger positioned in the first line, and a heat transfer fluid. The energy needed to heat, vaporize, and superheat the water may be obtained using a “buffer” heat transfer fluid. Advantageously many different types of heat transfer fluid may be used, depending on the industrial process in operation. For example, the heat transfer fluid can comprise any one of a source of steam, a combination of an alcohol (e.g., ethanol) and steam, a hot oil, ammonia, or a combination thereof. Optionally the reactant (i.e., input fluid) may be steam when a source is available and may be routed directly to the temperature control module for temperature elevation to the operating temperature. Separately, a pressure control module can be positioned in the first input line for changing the input pressure of the input water to the operating pressure.

The pressure control module may be a steam compressor positioned between the temperature control module and the electrolyzer, for example. During operation the input fluid is heated, vaporized and then compressed. Optionally the input water may be initially filtered, such as by reverse osmosis to remove undesirable components and can be stored in a feed surge drum.

FIG. 2 shows hydrogen separator system 20. Hydrogen and trace water 22 enters cooler 24. Cooled hydrogen and trace water 26 enters separator module 28 to yield hydrogen stream 32 and recovered water 34. Separator module 28 may be in communication with cooler 24. Cooler 24 may be disposed between an electrolyzer and the separator module 28. Cooler 24 cools hydrogen and trace water 22 such that the water vapor condenses from steam to liquid. Separator module 28 is configured to further separate the hydrogen gas from the liquid water, and may comprise a catalytic converter to convert trace oxygen to water. Separator system 20 may further comprise a solid-state device such as those having a membrane or separator permeable to hydrogen only to separate steam from the output hydrogen gas and/or oxygen gas. This may be accomplished at elevated temperatures and pressures without the need to cool a fluid stream. An adsorbent dryer on the final product can be used to enhance hydrogen purity. In addition to the hydrogen stream 32, an oxygen stream produced may also contain trace impurities, including hydrogen. The hydrogen may be removed catalytically and converted to water with a small amount of oxygen consumed. This is desirable for a case where high purity oxygen is desired, such as medical oxygen, oxygen for biomass gasification and nitric acid production.

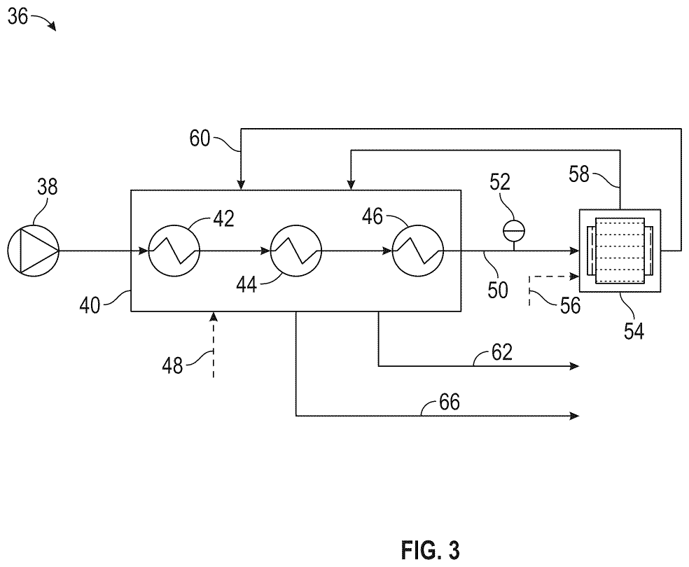

FIG. 3 shows system for producing hydrogen 36. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52.

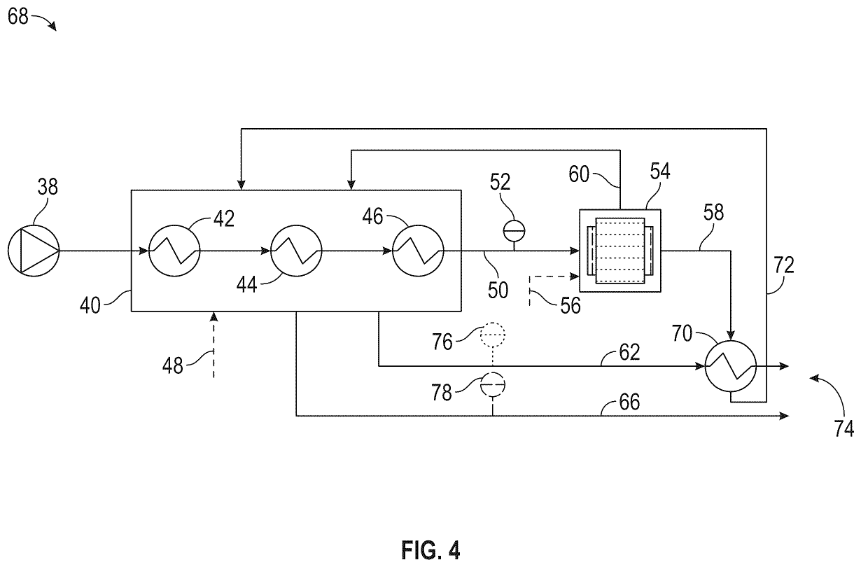

FIG. 4 shows system for producing hydrogen 68. Input reactant 38 enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Oxygen stream 60 enters heat exchanger module 40 to apply heat to input reactant 38. Hydrogen stream 58 enter hydrogen heat exchanger 70 to heat cooled hydrogen stream 62 and form secondary hydrogen stream 72. Secondary hydrogen stream 72 enters heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52. The temperatures of cooled hydrogen stream 62 and cooled oxygen stream 66 are measured by thermocouples 76 and 78, respectively. System for producing hydrogen 68 yields hydrogen about 300° C. and may use recoverable process heat to help heat the electrolyzer and/or input reactant 38.

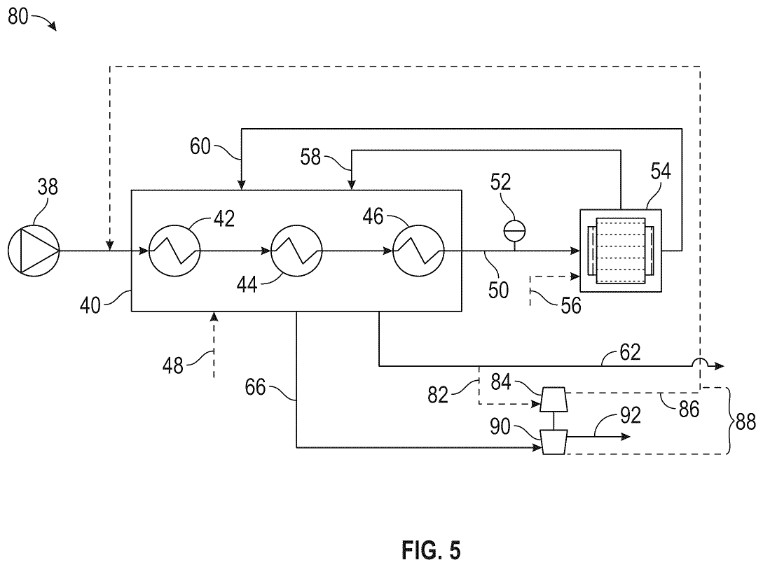

FIG. 5 shows system for producing hydrogen 80. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52. Hydrogen stream 82 may be separated from cooled hydrogen stream 62 and enter compressor wheel 84 of expander turbine 88. Expander wheel 90 furthers cool and/or liquify cooled oxygen stream 66 entering expander wheel 90 to yield low-temperature oxygen stream 92. Hydrogen stream 86 exiting compressor 84 is returned to input reactant 38. De-pressuring cooled oxygen stream 60 via expander turbine 88 provides the work needed to compress the limited hydrogen gas sent to the recycle loop back into input stream reactants 38.

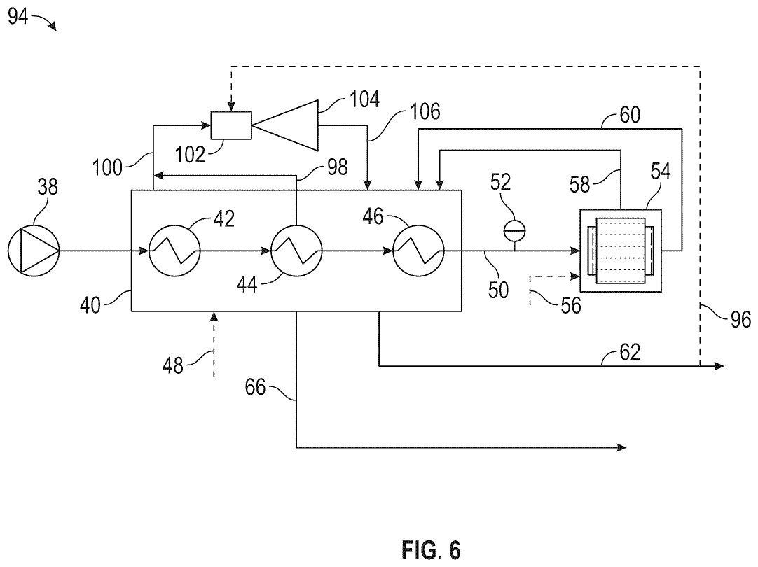

FIG. 6 shows system for producing hydrogen 94. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52. Hydrogen recycle stream 96 enters thermo-compressor 102 comprising venturi cone 104. Thermo-compressor 102 receives vapor and boiled fluid from input streams 100 and 98 and forms mixed hydrogen and steam stream 106 that is returned to heat exchanger module 40.

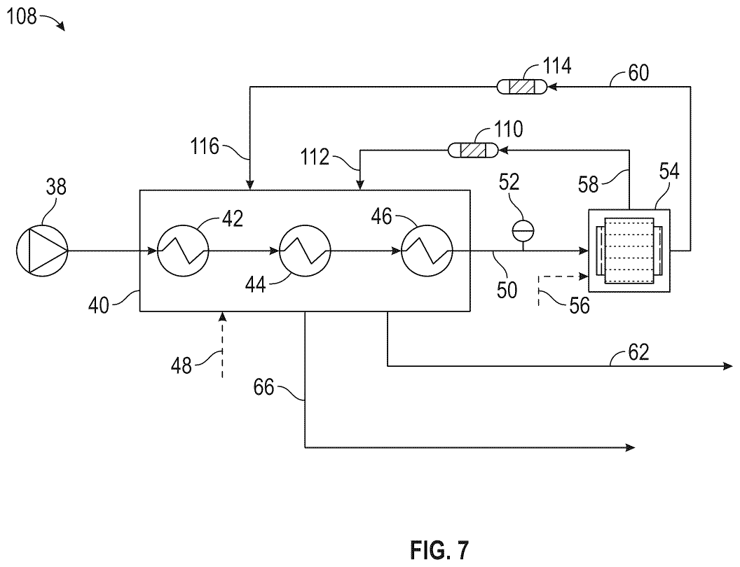

FIG. 7 shows system for producing hydrogen 108. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52. Catalytic converter 110 removes trace oxygen and converts the trace oxygen to water to form purified hydrogen stream 112. Catalytic converter 114 removed trace hydrogen and converts the trace hydrogen to water to form purified oxygen stream 116. Purified hydrogen stream 112 and purified oxygen stream 116 enter heat exchanger module 40.

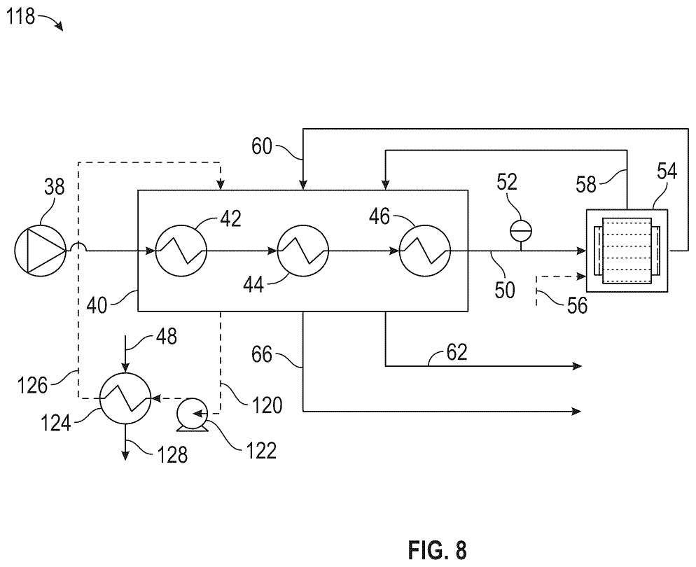

FIG. 8 shows system for producing hydrogen 118. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52. Liquid working fluid 120 (e.g., ethanol) is circulated into and out of heat exchanger module 40 to heat input reactant 38. Liquid working fluid 120 is conveyed by pump 122 into heat exchanger 124. Liquid working fluid 120 is heated by external process heat 48 (e.g., hot fluid or gas) to form heated liquid working fluid 126. Cooled output 128 is formed by heat exchanger 124. Heated liquid working fluid 126 enters heat exchanger module 40.

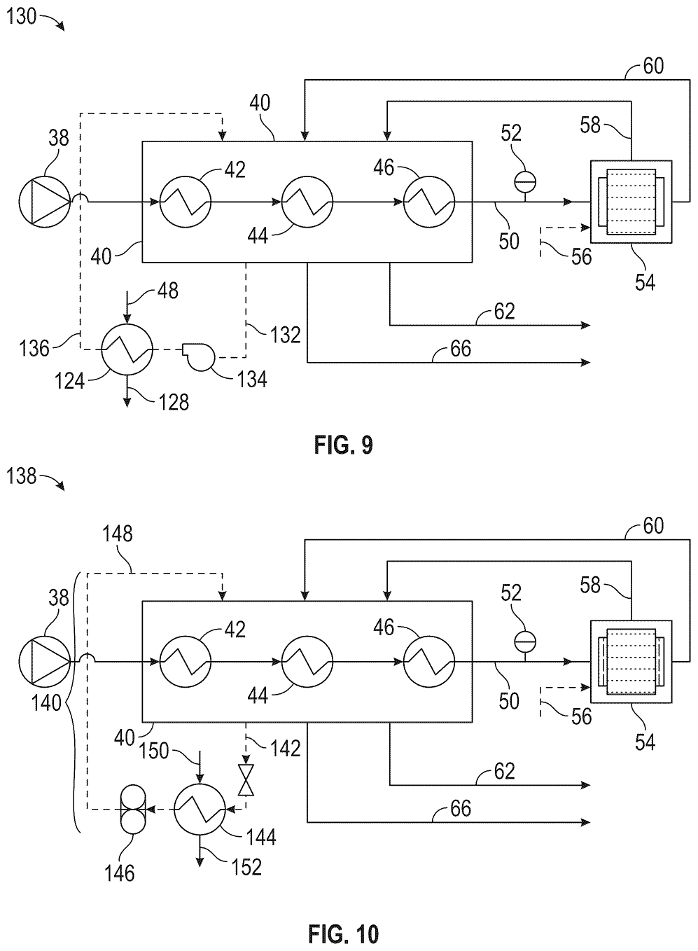

FIG. 9 shows system for producing hydrogen 130. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Heat exchanger module 40 received process heat 48 to increase the temperature of input reactant 38. The temperature of input stream 50 is measured by thermocouple 52. Liquid working fluid 120 (e.g., ethanol) is circulated into and out of heat exchanger module 40 to heat input reactant 38. Gaseous working fluid 132 is conveyed by gas blower 134 into heat exchanger 124. Gaseous working fluid 132 is heated by external process heat 48 (e.g., hot fluid or gas) to form heated gaseous working fluid 136. Cooled output 128 is formed by heat exchanger 124. Heated gaseous working fluid 136 enters heat exchanger module 40.

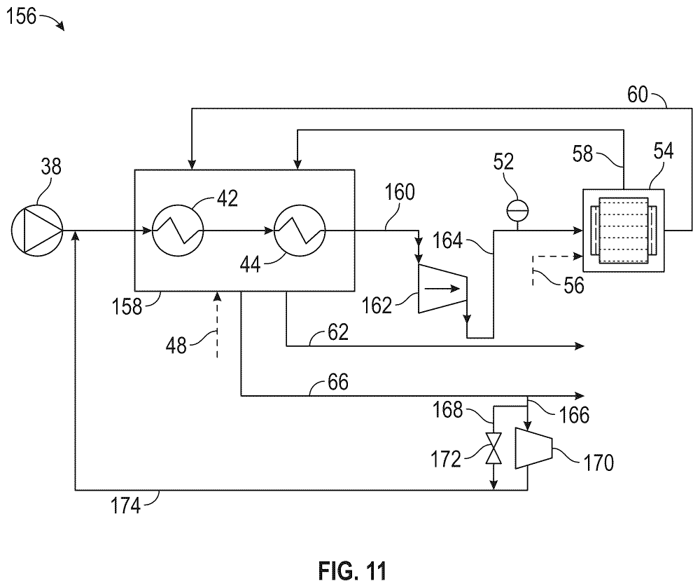

FIG. 10 shows system for producing hydrogen 138. Input reactant 38 (e.g., treated water) enters heat exchanger module 40 comprising warming module 42, boiler 44, and superheater 46. Warming module 42, boiler 44, and superheater 46 each comprise a heat exchanger. Input stream 50 enters electrolyzer 54. Input stream 50 may comprise steam, water, water vapor, oxygen, air gases, or a combination thereof. Electrolyzer 54 receives power input 56. Electrolyzer 54 produces hydrogen stream 58 and oxygen stream 60. Hydrogen stream 58 and oxygen stream 60 enter heat exchanger module 40 to apply heat to input reactant 38. Cooled hydrogen stream 62 and cooled oxygen stream 66 exit heat exchanger module 40. Gaseous working fluid 142 is heated by external process heat 150 (e.g., hot fluid or gas) which enters compressor 146 to form converted working fluid 140 which enters heat exchanger module 40. Cooled output 152 is formed by heat exchanger 144.

FIG. 11 shows system for producing hydrogen 156. Input reactant 38 (e.g., treated water) enters heat exchanger module 158 comprising warming module 42 and boiler 44. Warming module 42 and boiler 44 each comprise a heat exchanger. Input stream 160 enters compressor 162 to form a converted input stream 164. Input stream 160 may comprise steam, water, water vapor, oxygen, air gases, or a combination thereof. The temperature of converted input stream 164 is measured by thermocouple 52. Electrolyzer 54 receives power input 56. Electrolyzer 54 produces hydrogen stream 58 and oxygen stream 60. Hydrogen stream 58 and oxygen stream 60 enter heat exchanger module 158 to apply heat to input reactant 38. Cooled hydrogen stream 62 and cooled oxygen stream 66 exit heat exchanger module 158. Cooled oxygen stream 66 may be diverted into an input oxygen stream 166 enters compressor 170. Input oxygen stream 168 may pass through valve 172 to form converted oxygen stream 174. Converted oxygen stream 174 enters heat exchanger module 158.

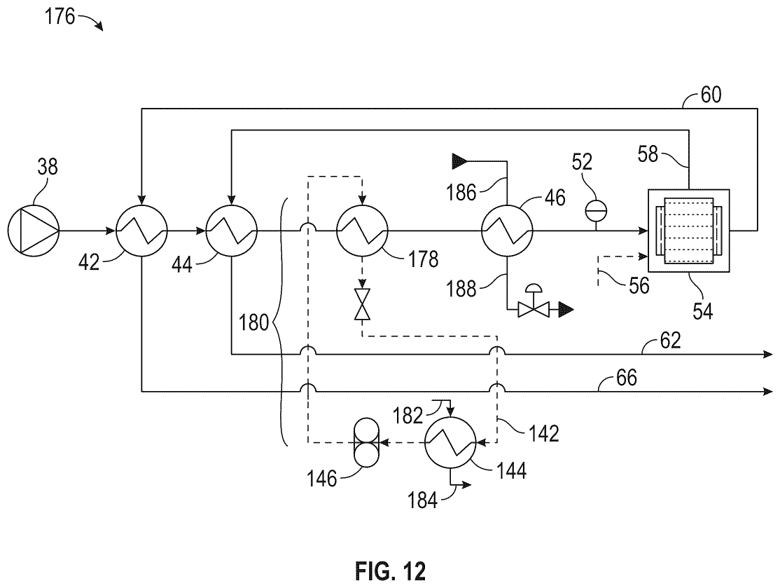

FIG. 12 shows system for producing hydrogen 176. Input reactant 38 (e.g., treated water) enters warming module 42 and boiler 44. Warming module 42 and boiler 44 each comprise a heat exchanger. Input reactant 38 may comprise steam, water, water vapor, oxygen, air gases, or a combination thereof. Input reactant 38 enters vaporizer 178 to form gaseous working fluid 142. First converted input stream enters superheater 46 to form recoverable process heat 186 and second converted input stream. Pressure generated by superheater 46 may be relieved by pressure control valve 188. The temperature of second converted input stream is measured by thermocouple 52. Electrolyzer 54 receives power input 56. Electrolyzer 54 produces hydrogen stream 58 and oxygen stream 60. Hydrogen stream 58 and oxygen stream 60 enter warming module 42 and/or boiler 44 to apply heat to input reactant 38. Cooled hydrogen stream 62 and cooled oxygen stream 66 exit warming module 42 and/or boiler 44. Gaseous working fluid 142 is heated by external process heat 182 (e.g., hot fluid or gas) which enters compressor 146 to form converted working fluid 180 which enters vaporizer 178. Cooled output 184 is formed by heat exchanger 144.

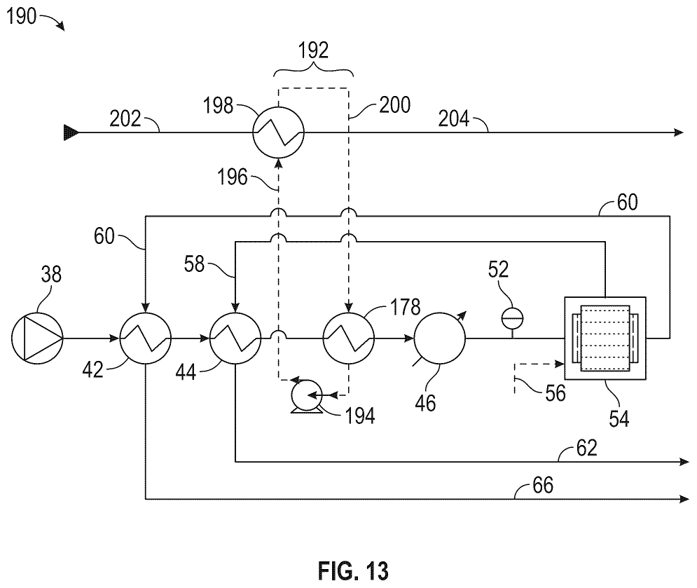

FIG. 13 shows system for producing hydrogen 190. Input reactant 38 (e.g., treated water) enters warming module 42 and boiler 44. Warming module 42 and boiler 44 each comprise a heat exchanger. Input reactant 38 may comprise steam, water, water vapor, oxygen, air gases, or a combination thereof. Input reactant 38 enters vaporizer 178 to form gaseous working fluid 194 which enters heat transfer buffer loop 192. Gaseous working fluid 194 enters heat transfer pump 194 to form a converted working fluid 196. Converted working fluid 196 enters heat exchanger 198 to heat external process fluid 202 and form heated external process fluid 204. Cooled working fluid 200 enters vaporizer 178. Gaseous working fluid 194 enters superheater 46. The temperature of gaseous working fluid 194 is measured by thermocouple 52. Electrolyzer 54 receives power input 56. Electrolyzer 54 produces hydrogen stream 58 and oxygen stream 60. Hydrogen stream 58 and oxygen stream 60 enter warming module 42 and/or boiler 44 to apply heat to input reactant 38. Cooled hydrogen stream 62 and cooled oxygen stream 66 exit warming module 42 and/or boiler 44.

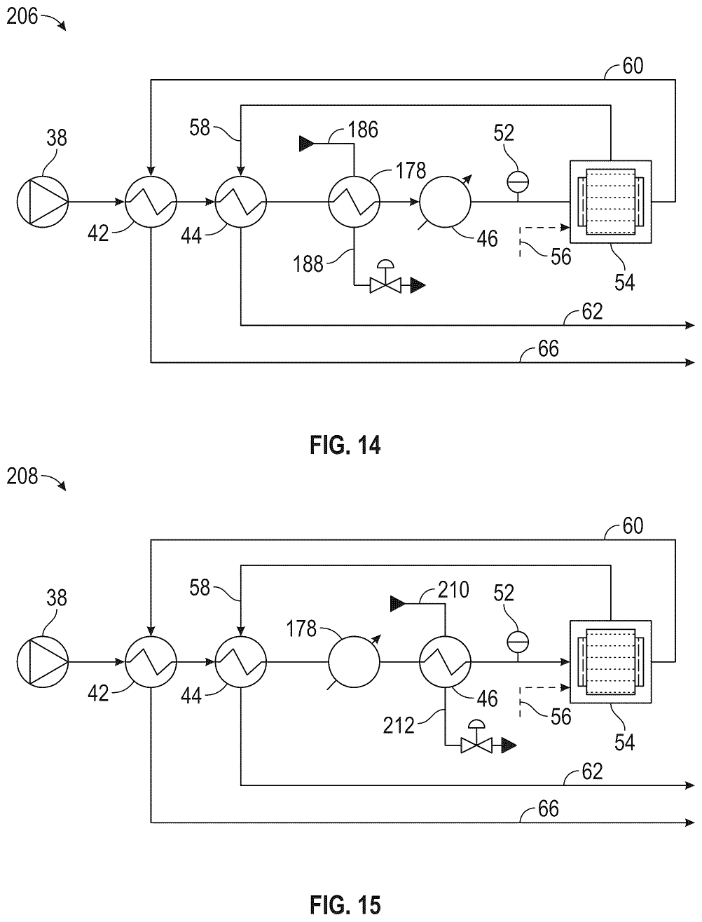

FIG. 14 shows system for producing hydrogen 206. Input reactant 38 (e.g., treated water) enters warming module 42 and boiler 44. Warming module 42 and boiler 44 each comprise a heat exchanger. Input reactant 38 may comprise steam, water, water vapor, oxygen, air gases, or a combination thereof. Input reactant 38 enters vaporizer 178 to form recoverable process heat 186 and converted input stream. Pressure generated by vaporizer 178 may be relieved by pressure control valve 188. Converted input stream enters superheater 46. The temperature of converted input stream is measured by thermocouple 52. Electrolyzer 54 receives power input 56. Electrolyzer 54 produces hydrogen stream 58 and oxygen stream 60. Hydrogen stream 58 and oxygen stream 60 enter warming module 42 and/or boiler 44 to apply heat to input reactant 38. Cooled hydrogen stream 62 and cooled oxygen stream 66 exit warming module 42 and/or boiler 44.

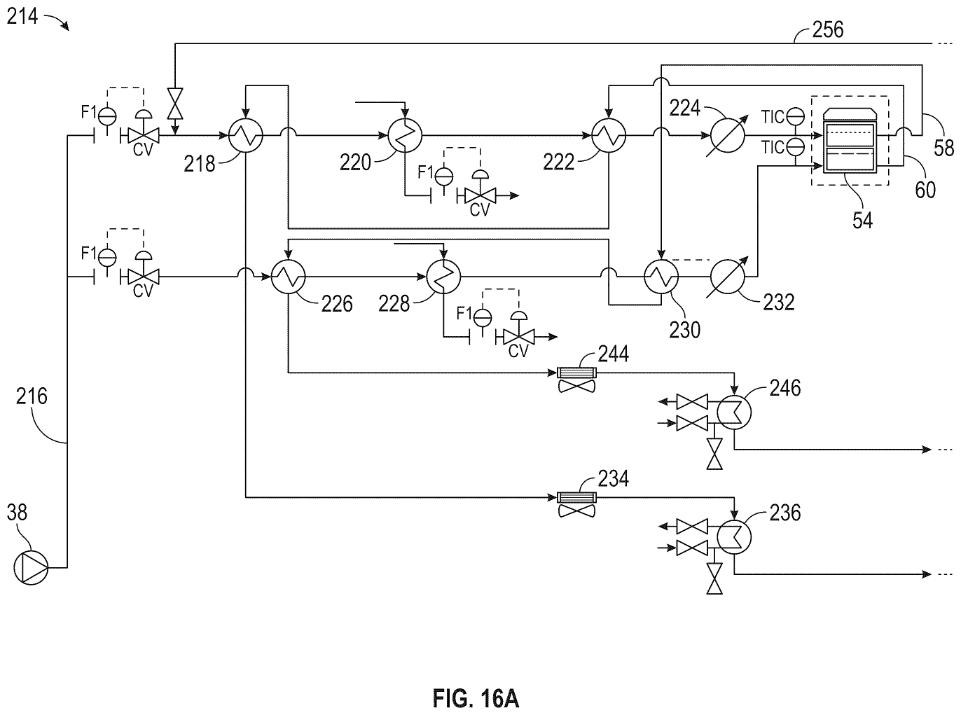

FIG. 15 shows system for producing hydrogen 208. Input reactant 38 (e.g., treated water) enters warming module 42 and boiler 44. Warming module 42 and boiler 44 each comprise a heat exchanger. Input reactant 38 may comprise steam, water, water vapor, oxygen, air gases, or a combination thereof. Input reactant 38 enters vaporizer 178 to form a first converted input stream. First converted input stream enters superheater 46 to form recoverable process heat 186 and second converted input stream. Pressure generated by superheater 46 may be relieved by pressure control valve 212 The temperature of second converted input stream is measured by thermocouple 52. Electrolyzer 54 receives power input 56. Electrolyzer 54 produces hydrogen stream 58 and oxygen stream 60. Hydrogen stream 58 and oxygen stream 60 enter warming module 42 and/or boiler 44 to apply heat to input reactant 38. Cooled hydrogen stream 62 and cooled oxygen stream 66 exit warming module 42 and/or boiler 44.

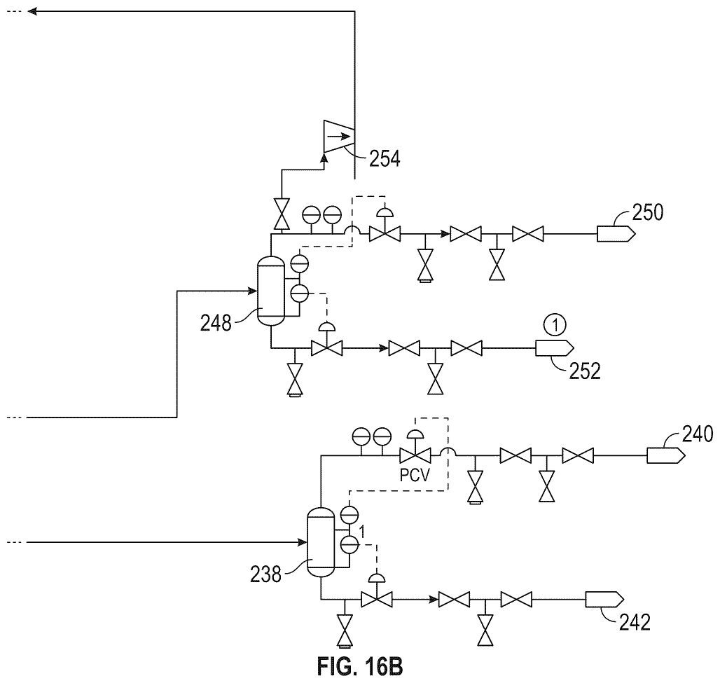

FIGS. 16A to 16B show system for producing hydrogen 214. Input reactant 38 (e.g., treated water) enters cathode economizer 218, cathode vaporizer 220, cathode recuperator 222, and cathode superheater 224 to form a gaseous working fluid. Input reactant 38 (e.g., treated water) enters anode economizer 226, anode vaporizer 228, anode recuperator 230, and anode superheater 232 to form a gaseous working fluid. The gaseous working fluid enters electrolyzer 54. Electrolyzer 54 produces hydrogen stream 58 and oxygen stream 60. Hydrogen stream 58 enters anode recuperator 230, anode economizer 226, cathode condenser 244, cathode cooler 246, and cathode separator 248 to form hydrogen product 250, water 252, and output stream. Output stream enters recycle compressor 254 to form converted output stream 256. Converted output stream 256 enters cathode economizer 218. Oxygen stream 60 enters cathode recuperator 222, cathode economizer 218, anode condenser 234, anode cooler 236, and anode separator 238 to form oxygen byproduct 240 and water 242.

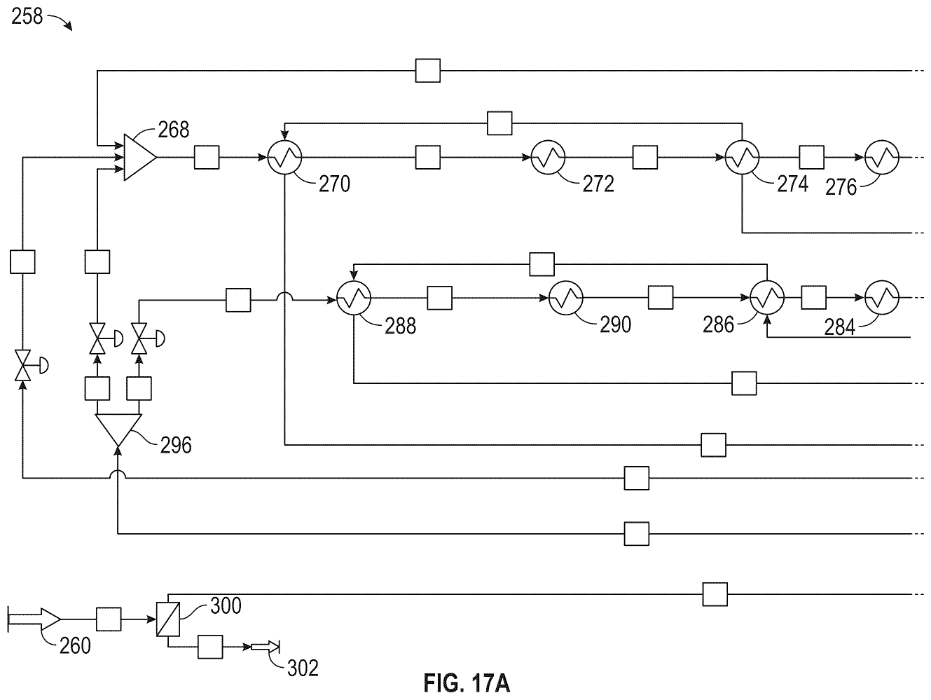

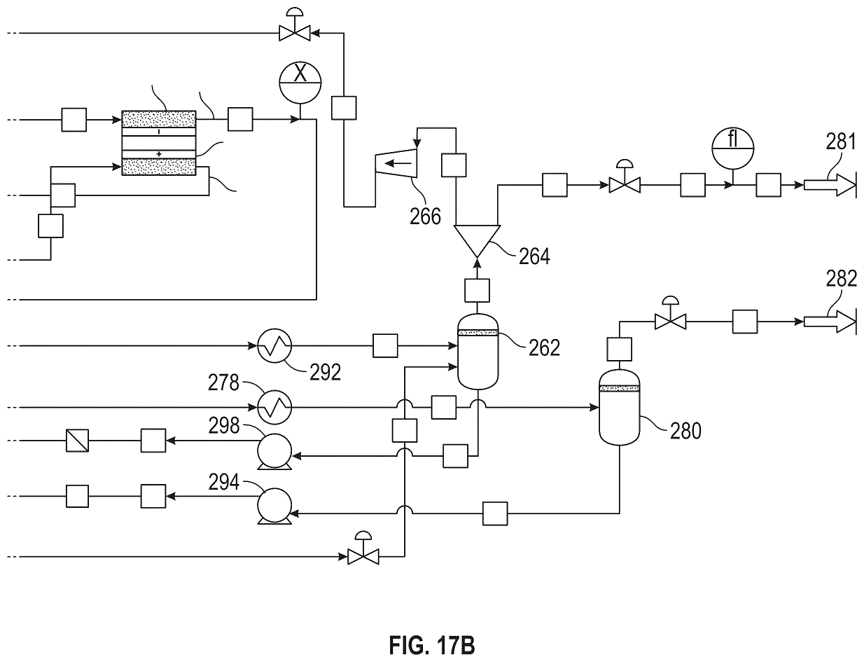

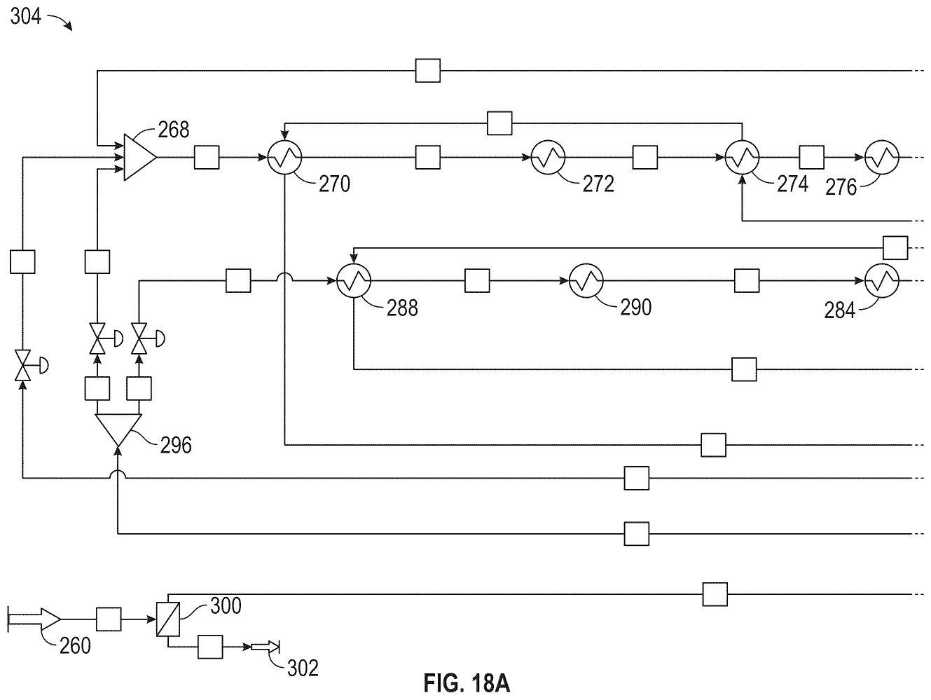

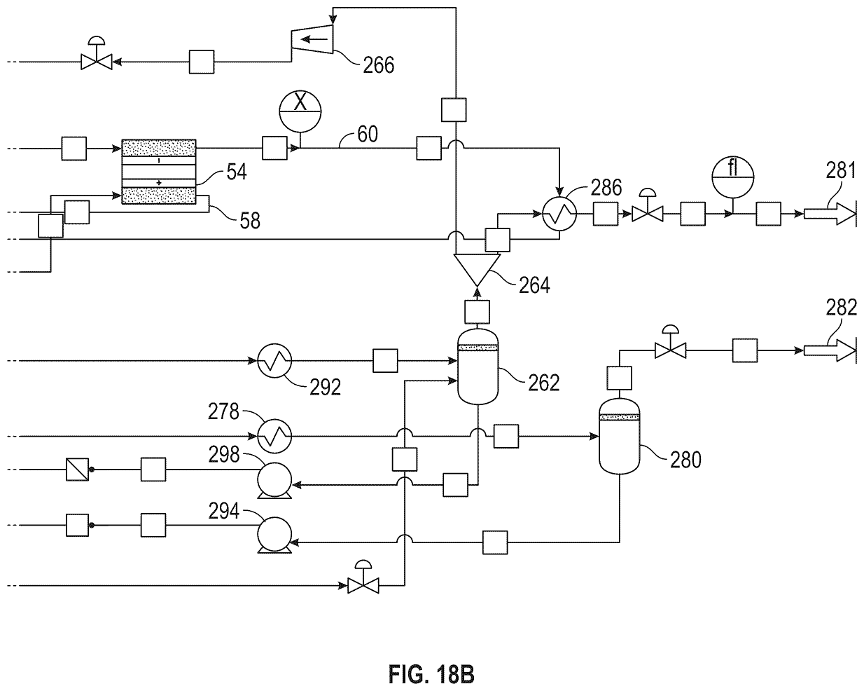

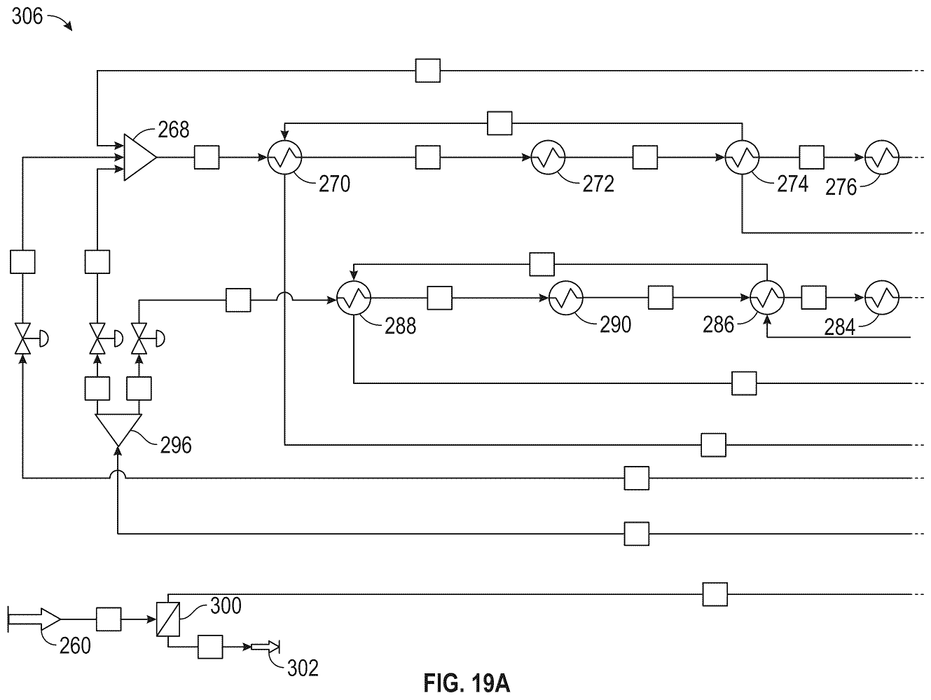

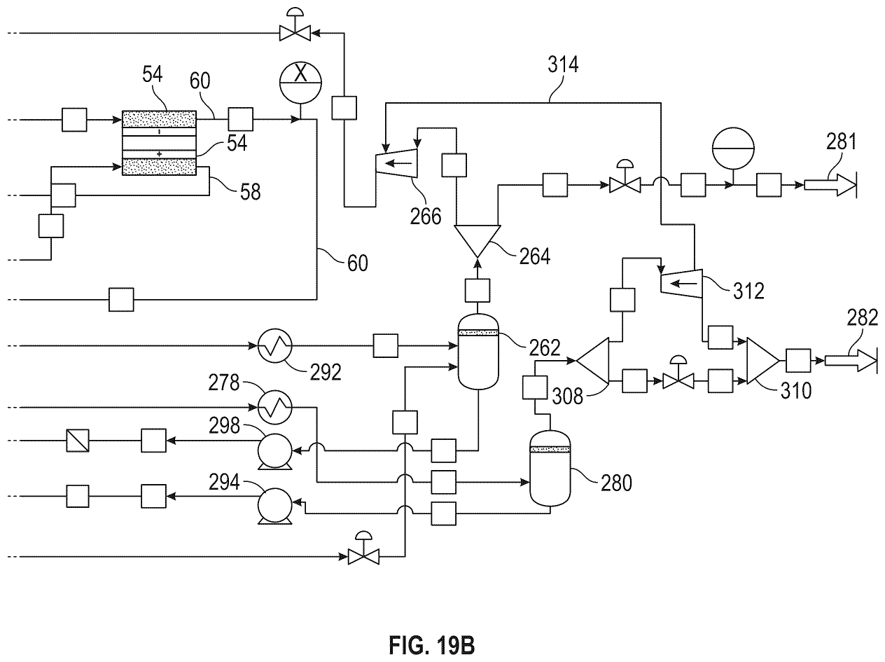

FIGS. 17A to 17B, 18A to 18B, and 19A to 19B show system for producing hydrogen 258, 304, and 306, respectively. In FIGS. 17A to 17B, input reactant 260 (e.g., treated water) enters reverse osmosis filter 300 to form recovered fluid 302 and input stream. Input reactant 260 may comprise steam, water, water vapor, oxygen, air gases, or a combination thereof. Input stream enters cathode separator 262. Input stream exits cathode separator 262 through venturi cone 264 and enters recycle compressor 266. Input stream enters cathode economizer 270 through venturi cone 268. Input stream enters cathode vaporizer 272 followed by cathode recuperator 274 and cathode superheater 276. Input stream enters electrolyzer 54. Electrolyzer 54 produces hydrogen stream and oxygen stream. Hydrogen and/or oxygen stream enters anode recuperator 286 and anode superheater 284 and reenters electrolyzer 54. Hydrogen stream enters anode economizer 288, cathode cooler 292, and cathode separator 262. Hydrogen stream exits cathode separator 262, enters venturi cone 264 to produce hydrogen product 281. Oxygen stream enters cathode recuperator 274, cathode economizer 270, and anode cooler 278, and anode separator 280 to form oxygen byproduct 282. Output stream from cathode separator 262 enters cathode pump 298 and enters cathode economizer 270 through venturi cone 268. Output stream from anode separator 280 enters recycle pump 294 and enters venturi cone 296. From the venturi cone 296 output stream from anode separator 280 enters anode economizer 288 and/or enters cathode economizer 270 through venturi cone 268. Alternatively, in FIGS. 18A to 18B, hydrogen stream exits electrolyzer 54 and enters anode recuperator 286 to form a hydrogen product 281. In FIGS. 19A to 19B, oxygen stream exits anode separator 280 and enters expander turbine 312 through venturi cone 308. The oxygen stream enters venturi cone 310 to form oxygen byproduct 282 and/or enters recycle compressor 266 and provides power to the recycle compressor 266.

The system may be configured to receive an input reactant (such as water) and convert the input reactants to output products using recoverable process heat, and may comprise an input line supplying input water; a superheater adapted to heat the input water to superheated steam; and an electrolyzer operatively connected to the superheater; each operating at an operating temperature and an operating pressure, wherein the electrolyzer converts the input steam into output gases and vapors, and wherein recoverable process heat may be introduced at the superheater to superheat the input water to superheated steam.

The system may comprise a heat pump. The heat pump may comprise a vaporizer, a heat exchanger, a compressor, or a combination thereof. The heat pump may provide heat to heat and/or vaporize an input reactant (e.g., treated water) by a direct and/or indirect process. For example, in an indirect heat transfer process, low pressure steam may be provided to the heat exchanger to transfer heat to a heat pump heat exchange medium, which in turn may transfer heat to an input reactant to form a heated and/or vaporized reactant. Alternatively, in a direct heat transfer process, low pressure steam may transfer heat directly to an input reactant through the heat pump to may transfer heat to an input reactant to form a heated and/or vaporized reactant. The heat pump may or may not use recoverable process heat from a downstream step and/or system component to heat and/or vaporize an input reactant.

Heat pumps as disclosed herein may be advantageous where the heat from a relatively constant source of relatively low-temperature heat such as steam may be transferred to a heat pump heat exchange medium for heating the input water. For example, the electrolyzer may be operated at an operating pressure of between about 9.5 bar (g) to about 10.5 bar (g). Steam at pressures lower than 9.5 bar (g) (i.e. low-pressure steam) may be used to drive the vaporization of the input water (typically after initial heating of the input stream using heat transferred from the output streams), with an important difference. The heat pump system may transfer thermal energy to the low-pressure steam to provide the thermal energy needed for vaporization at an operating pressure electrolyzer pressure of 10 bar (g) or greater. This may allow for electrolyzer operation at relatively high pressures and the production of relatively high-pressure output gases when compared to other electrolyzer systems and/or methods. A person skilled in the art will understand that this example is merely illustrative and not meant to limit the present invention to the example. Heat pumps using low-pressure steam may be advantageous since low-pressure steam may be readily available at most industrial sites and may provide a useful and underused source of heat which may be put to work upgrading low grade heat to higher pressure steam at relatively low cost.

A system configuration comprising a heat pump may increase energy efficiency relative to a configuration that does not comprise a heat pump. For example, heat transfer fluid may comprise a compressed fluid to form a hot energy supply stream. By transferring energy through a heat exchanger to warm and/or vaporize an input reactant (e.g., treated water), the heat transfer fluid may condense to a liquid phase. The liquid phase may pass through a valve to reduce the pressure of the liquid phase. The liquid phase may be vaporized at a lower temperature using low-grade heat such as low-pressure steam.

The system may comprise a heat exchanger module. The heat exchanger module may comprise, but is not limited to, a converter module, a boiler, a superheater, a vaporizer, a compressor, or a combination thereof. The heat exchanger module may or may not comprise a converter module. The converter module may comprise, but is not limited to, a superheater, a vaporizer, a compressor, or a combination thereof.

The heat exchanger module may be configured to receive excess process electricity, heat, and/or power. The heat exchanger module may be configured to receive recoverable process heat to increase the temperature of an input reactant (e.g. treated water). The recoverable process heat may comprise heated hydrogen and/or heated oxygen. Heated hydrogen and/or heated oxygen may be formed by an electrolyzer. Liquid working fluid (e.g., ethanol) may be circulated into and out of heat exchanger module to heat and/or vaporize input reactant.

A vaporized phase comprising the input reactant may be formed by the heat exchanger module. The vaporized phase comprising the input reactant may be passed into a converter module to form a converted steam. The converted steam may comprise a higher temperature and/or pressure than the vaporized phase comprising the input reactant. The converted steam may comprise a lower temperature and/or pressure than the vaporized phase comprising the input reactant.

The converted steam may be passed into an electrolyzer to form hot hydrogen gas and hot oxygen gas. Hot hydrogen gas and/or hot oxygen gas may be passed into a heat exchanger module. Hot hydrogen gas and/or hot oxygen gas may be passed into a converter module. Hot hydrogen gas and/or hot oxygen gas may comprise recoverable process heat that may be used in a heat exchanger module to transfer thermal energy to an input reactant (e.g. treated water).

The system may comprise an expander turbine. The expander turbine may be in communication with a heat exchanger module and/or converter module. For example, the expander turbine may increase pressure on a portion of a hydrogen product stream and/or oxygen byproduct stream routed to the feedback line, for example from 9.6 bar (g) level to 10.6 bar (g). This may increase the flow of the hydrogen product stream and/or oxygen byproduct stream. In another example, the energy of a hydrogen product stream and/or oxygen byproduct stream may be captured by de-pressuring the stream through the expander turbine.

A portion of the hydrogen gas evolved at the electrolyzer may be routed back to the electrolyzer via a recycle line. Introduction of hydrogen may protect the electrodes and increase useful life of the electrolyzer. This may be accomplished by de-pressuring a portion of a product oxygen stream through an expander turbine configured to compress limited hydrogen gas in a recycle loop. Delivery of hydrogen gas to the electrolyzer may be accomplished through the use of a thermo-compressor (e.g., an ejector or jet pump) in a recycle line adapted to push a portion of hydrogen gas to the electrolyzer. Optionally, a second output line adapted to receive the oxygen gas may comprise an expander turbine, and operation of the expander turbine may increase pressure on a portion of the hydrogen product stream routed to the recycle line, for example from 9.6 bar (g) level to 10.6 bar (g). This may increase flow of a portion of the hydrogen stream to the electrolyzer. The energy of the oxygen gas stream may be captured by de-pressuring the oxygen gas through an expander turbine. The expander turbine may comprise a compressor head configured to compress a smaller hydrogen stream. Once the hydrogen pressure is increased a small amount (i.e. around 1 bar) the hydrogen gas may flow back to the cathode inlet line through the recycle line.

The system may comprise an additional heat transfer buffer loop. An additional heat transfer buffer loop may be appropriate where an external process heat cannot be used directly to heat an input reactant (e.g. treated water). For example, heat transfer fluids such as a therminol may be used as intermediates between the recoverable process heat and the input reactant in situations where it is preferable to not use the recoverable process heat directly. Those situations may include, for example, where the recoverable process heat available is some distance away from the input reactant and therefore the input reactant may not have sufficient pressure and/or thermal energy for use at the electrolyzer.

The electrolyzer may comprise a cell area. The cell area may be between about 0 cm² to about 1000 cm², about 10 cm² to about 900 cm², about 20 cm² to about 800 cm², about 30 cm² to about 700 cm², about 40 cm² to about 600 cm², about 50 cm² to about 500 cm², about 60 cm² to about 400 cm², about 70 cm² to about 300 cm², about 80 cm² to about 200 cm², about 90 cm² to about 100 cm², or about 1000 cm².

The electrolyzer may comprise at least one anode and at least one cathode. A carrier gas may be provided to the cathode and/or anode via an inlet. The carrier gas may comprise, but is not limited to, hydrogen gas, nitrogen gas, helium gas, or a combination thereof. The carrier gas may be mixed with hydrogen and/or oxygen gas formed by the electrolyzer. For example, nitrogen gas may mix with oxygen gas formed by the electrolyzer and the combined gases may exit the anode via an outlet. The carrier gas flow rate in the inlet may be between about 0.0 std-mL/min to about 40 std-mL/min, about 5 std-mL/min to about 35 std-mL/min, about 10 std-mL/min to about 30 std-mL/min, about 15 std-mL/min to about 25 std-mL/min, or about 40 std-mL/min.

Water may be provided to the cathode inlet and/or anode inlet. The stoichiometry number (i.e. water to the cathode inlet divided by the water converted on the cathode side of the electrolyzer) may be between about 1 to about 10, about 2 to about 9, about 3 to about 8, about 4 to about 7, about 5 to about 6, or about 10. The anode water factor (i.e. the ratio of anode inlet water to cathode inlet water) may be between about 0.5 to about 4, about 1 to about 3.5, about 1.5 to about 3, about 2 to about 2.5, or about 4.

The stoichiometry of the chemical reaction equations at the cathode and anode can be seen in Equations 1 and 2 below.

$$Cathode : 2 {H}_{2} O + 2 {e}^{-} \to 1 {H}_{2} + 2 {OH}^{-} \qquad Equation 1.$$

$$Anode : 2 {OH}^{-} \to 2 {e}^{-} + \frac{1}{2} {O}_{2} + 1 {H}_{2} O \qquad Equation 2.$$

Water converted by the electrolyzer is based on cell area and current density. The water consumed by the cathode (represented as the value for a stoichiometry number of one (1), is shown in Equation 3 below, where C is Coulombs, and mol is a gram-based quantity (i.e. gram-mol).

$$Cathode Water , \frac{g}{min} = ( Cell Area , {cm}^{2} * 0.5 \frac{A}{{cm}^{2}} * \frac{1 \frac{C}{s}}{1 A} * \frac{1 {mole}^{-}}{96 , 485.33 C} ) * ( \frac{2 mol H 2 O}{2 mole} * \frac{18.01529 g H 2 O}{1 mol H 2 O} ) * \frac{60 sec}{min} \qquad Equation 3.$$

The method may comprise operating the electrolyzer at a single cell voltage of between about 1.0 V to about 2.4 V, about 1.2 V to about 2.2 V, about 1.4 V to about 2.0 V, about 1.6 V to about 1.8 V, or about 2.4 V.

The method may comprise operating the electrolyzer at a current density of between about 0.0 A/cm² to about 8.0 A/cm², about 0.2 A/cm² to about 7.5 A/cm², about 0.3 A/cm² to about 7.0 A/cm², about 0.4 A/cm² to about 6.5 A/cm², about 0.5 A/cm² to about 6.0 A/cm², about 0.6 A/cm² to about 5.5 A/cm², about 0.7 A/cm² to about 5.0 A/cm², about 0.8 A/cm² to about 4.5 A/cm², about 0.9 A/cm² to about 4.0 A/cm², about 1.0 A/cm² to about 3.5 A/cm², about 1.2 A/cm² to about 3.0 A/cm², about 1.4 A/cm² to about 2.5 A/cm², about 1.5 A/cm² to about 2.0 A/cm², or about 8 A/cm².

The method may comprise heating input reactant (e.g. treated water) in several stages and converting the input reactant to output gases (e.g. hydrogen and oxygen). An optional first stage of heating may comprise using recoverable process heat from the output gases, typically a first output gas such as oxygen and a second output gas such as hydrogen and/or water vapor. For example, a first heat exchanger may transfer heat from a first output gas to an input reactant in the input line, and a second heat exchanger may transfer heat from a second output gas to an input reactant in the input line. These heat exchangers may raise the temperature of the input reactant until the input reactant is heated and/or vaporized. A second stage of heating may use low pressure steam and/or a heat pump to heat the heated and/or vaporized input reactant. Recoverable process heat may be introduced at a superheater. The superheater may adapt to heat the input reactant (now vapor) to superheated steam for delivery to the electrolyzer. The electrolyzer may convert the superheated steam into output gases. The heat transfer mediums and/or input reactant may comprise a steam and/or vapor phase. Other mediums suitable for heat transfer for these embodiments will be readily apparent to those skilled in the art given the benefit of this disclosure. These may comprise, but are not limited to, low-pressure steam, recoverable process heat, a heat pump heat exchange medium, or a combination thereof. Alternatively, the external process heat may be sufficient such that the second stage of heating using low pressure steam and/or a heat pump is not required. The recoverable process heat may be introduced at the vaporizer. The recoverable process heat may be sufficient to be introduced at the superheater (without need for the heat pump) for superheating the input reactant. The recoverable process heat may comprise a temperature in excess of an operating temperature of the electrolyzer.

Water that is heated and/or vaporized and superheated may comprise a lower boiling point (e.g. about 138° C.). Most of the energy needed to convert inlet water to superheated steam may be provided in a vaporization step. At a low operating pressure, plentiful low pressure steam at a refinery and/or petrochemical sites may be used to provide this energy. For example, a typical low pressure steam header is 3.5 bar (g), condensing at 148° C. This may provide a 10° C. delta-T for transfer of energy in a heat exchanger. Thus, the electrolyzer may be operated at relatively low pressure using low pressure steam to drive vaporization of an input reactant. The temperature control module may comprise a heat exchanger positioned in a first line, and a heat transfer fluid, wherein the heat transfer fluid may comprise a source of steam, a combination of an alcohol and/or steam, a hot oil, ammonia, or a combination thereof. Many different sources of heat may be used, either alone or in combination, to heat the input steam to an operating temperature suitable for use in the electrolyzer. Recoverable process heat from electrolyzer output products and/or gases may be used to heat the input reactant in a heat exchanger module.

Embodiments of the present invention provide a technology-based solution that overcomes existing problems with the current state of the art in a technical way to satisfy an existing problem for operators generating excess process heat. Embodiments of the present invention achieve important benefits over the current state of the art, such as a heat exchanger module and convertor module configured to receive process heat. Some of the unconventional steps of embodiments of the present invention include a heat exchanger module comprising a warming module and boiler, each configured to receive process heat and/or heat from a hot electrolyzer stack product (e.g., hydrogen and/or oxygen); and a convertor module configured to receive process heat and/or heat from a hot electrolyzer stack product (e.g., hydrogen and/or oxygen).

The term of degree “substantially” as used herein means a reasonable amount of deviation of the modified term such that the end result is not significantly changed. Note that in the specification and claims, “about” or “approximately” means within twenty percent (20%) of the numerical amount cited. The terms, “a”, “an”, “the”, and “said” mean “one or more” unless context explicitly dictates otherwise. The term “and/or” as used herein means that the listed items are present, or used, individually or in combination. In effect, this term means that “at least one of” or “one or more” of the listed items is present or used.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A system for producing hydrogen gas comprising:
a heat exchanger module;
said heat exchanger module comprising:
a warming module; and
a boiler;
a converter module;
an electrolyzer in communication with said converter module;
said electrolyzer in communication with said heat exchanger module; and
said heat exchanger module configured to receive process heat.

2. The system of claim 1 wherein said converter module comprises a superheater.

3. The system of claim 1 wherein said converter module comprises a vaporizer.

4. The system of claim 1 wherein said converter module comprises a compressor.

5. The system of claim 1 wherein said heat exchanger module is configured to receive excess process power.

6. The system of claim 1 wherein said heat exchanger module is configured to receive excess process electricity.

7. The system of claim 1 wherein said heat exchanger module is configured to receive heat from heated hydrogen.

8. The system of claim 1 wherein said heat exchanger module is configured to receive heat from heated oxygen.

9. The system of claim 1 wherein said converter module is configured to receive heat from heated hydrogen.

10. The system of claim 1 wherein said converter module is configured to receive heat from heated oxygen.

11. The system of claim 1 further comprising an expander turbine in communication with said heat exchanger module.

12. The system of claim 1 further comprising a hydrogen heat exchanger in communication with said electrolyzer and said heat exchanger module.

13. The system of claim 1 further comprising a thermo-compressor in communication with said heat exchanger module.

14. The system of claim 1 further comprising a working fluid.

15. A method for producing hydrogen gas comprising:
passing water into a heat exchanger module comprising warming module and a boiler to form a vapor-phase water;
passing the vapor-phase water into a converter module to form a converted steam;
passing the converted steam into an electrolyzer to form hot hydrogen gas and hot oxygen gas;
transferring heat from the hot oxygen to the converter module; and
transferring process heat into the heat exchanger module.

16. The method of claim 15 further comprising passing the hot oxygen gas into the heat exchanger module.

17. The method of claim 15 further comprising passing the hot hydrogen gas into the heat exchanger module.

18. The method of claim 15 wherein the converter module comprises a superheater.

19. The method of claim 15 wherein the converter module comprises a vaporizer.

20. The method of claim 15 wherein the converter module comprises a compressor.
